(19) United States
(12) Patent Application Publication
(10) Pub. No.: US 2023/0409992 A1
(43) Pub. Date: Dec. 21, 2023

(54) USER INTERFACE AND IMPLEMENTATION FOR APPLICATION SERVICE CUSTOM LOGIC

(71) Applicant: SAP SE, Walldorf (DE)

(72) Inventors: Pradeep Kumar SINGH, Bengaluru (IN); Sumit CHOWDHRY, Bangalore (IN); Adithya UDAY, Bangalore (IN); Prabhu Mallappa YANDIGEN, Bangalore (IN); Vishwanath TELSANG, Bagalkot (IN); Vingesh NAYAR, Palakkad (IN); Sasi Kanth VELAGALETI, Vijayawada (IN); Prathiba ARAVIND, Bangalore (IN); Pulagam HINDU, Guntur (IN); Roohi GANATRA, Gujarat (IN)

(21) Appl. No.: 17/840,805

(22) Filed: Jun. 15, 2022

(51) Int. Cl. G06Q 10/06; G06F 9/54; G06F 8/70

(52) U.S. Cl. CPC G06Q 10/063; G06Q 10/067; G06F 9/54; G06F 8/70

(57) ABSTRACT

Some embodiments may be associated with a system to extend business logic for cloud application services. A custom logic user interface may receive, from a user via a flow-based editor, information creating a custom logic business expression (e.g., a determination or a validation) and information about the custom logic business expression may be stored in a custom logic metadata repository. A computer processor of an application service platform may access the custom logic business expression from the custom logic metadata repository and receive an Application Programming Interface (“API”) call from an API consumer. Responsive to the API call, the system may arrange for execution of the custom logic business expression in accordance with information in the custom logic metadata repository and invoke a pre-hook trigger event to call a custom logic service. Standard application logic may then be executed, and a post-hook trigger event may be invoked to call the custom logic service. A result can then be returned from the application service platform to the API consumer.

### BACKGROUND

An enterprise may use applications to perform business functions. For example, cloud-based applications are increasingly used to process purchase orders, handle human resources tasks, interact with customers, etc. A cloud computing environment may have a Software Development Kit (“SDK” with scripts which can be used to create custom logic, such as the SAP® Advanced Business Script Language (“ABSL”). Using ABSL, a designer can implement, for example, events, validations, and actions that are defined for business objects in a solution. Note that such languages are not just for defining and describing objects but may also be used to create logic itself (and contain everything necessary to implement advanced functionality). Such tools, however, are not for business users or key users but rather professional developers who must learn the syntax of the language, learn the usage of SDK tool, study the underlying business objects and/or architecture, follow a complex deployment process, etc. Hiring external developers can be costly and thus increase the total cost of acquisition of the desired product behavior. Similarly, using external developers can be a time consuming and error prone process. These challenges apply to many existing vendors and/or products with custom logic capability.

It would be desirable to extend business logic for cloud application services in a secure, efficient, and accurate manner.

### SUMMARY

Methods and systems may be associated with a system to extend business logic for cloud application services. A custom logic user interface may receive, from a user via a flow-based editor, information creating a custom logic business expression (e.g., a determination or a validation) and information about the custom logic business expression may be stored in a custom logic metadata repository. A computer processor of an application service platform may access the custom logic business expression from the custom logic metadata repository and receive an Application Programming Interface (“API”) call from an API consumer. Responsive to the API call, the system may arrange for execution of the custom logic business expression in accordance with information in the custom logic metadata repository and invoke a pre-hook trigger event to call a custom logic service. Standard application logic may then be executed, and a post-hook trigger event may be invoked to call the custom logic service. A result can then be returned from the application service platform to the API consumer.

Some embodiments comprise: means for receiving, by a custom logic user interface from a user via a flow-based editor, information creating a custom logic business expression; means for storing the custom logic business expression in a custom logic metadata repository; means for receiving at an application service platform an API call from an API consumer; means for arranging, by a computer processor of the application service platform, for execution of the custom logic business expression in accordance with information in the custom logic metadata repository; responsive to the API call, means for invoking a pre-hook trigger event to call a custom logic service from the application service platform; means for executing standard application logic at the application service platform; means for invoking a post-hook trigger event to call the custom logic service from the application service platform; and means for returning a result from the application service platform to the API consumer.

Some technical advantages of some embodiments disclosed herein are improved systems and methods to extend business logic for cloud application services in a secure, efficient, and accurate manner.

### BRIEF DESCRIPTION OF THE DRAWINGS

FIG. 1 is a high-level architecture for a system in accordance with some embodiments.

FIG. 2 illustrates a method according to some embodiments.

FIG. 3 is a custom logic determination editor user interface in accordance with some embodiments.

FIG. 4 is a determination editor header block user interface according to some embodiments.

FIG. 5 is a determination editor condition block user interface in accordance with some embodiments.

FIG. 6 is a condition block with multiple sets of conditions according to some embodiments.

FIG. 7 is a determination editor assignment block in accordance with some embodiments.

FIG. 8 is an assignment block with multiple assignments according to some embodiments.

FIG. 9 is an assignment block function selection in accordance with some embodiments.

FIG. 10 is a custom logic validation editor user interface according to some embodiments.

FIG. 11 is a validation editor condition block user interface in accordance with some embodiments.

FIG. 12 is a validation editor action block user interface according to some embodiments.

FIG. 13 is a custom logic design time framework in accordance with some embodiments.

FIG. 14 is a custom logic information flow according to some embodiments.

FIG. 15 is a system to support API messages for custom logic in accordance with some embodiments.

FIG. 16 is an apparatus or platform according to some embodiments.

FIG. 17 illustrates a custom logic database in accordance with some embodiments.

FIG. 18 is a human machine interface display in accordance with some embodiments.

FIG. 19 illustrates a handheld tablet computer according to some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will now be described. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

It is very common for customers to want to customize vendor provided cloud application solutions. For example, a customer might want to extend and/or customize vendor delivered entities based on business needs in simple way without getting overridden by subsequent vendor deliveries. Moreover, a business user should be possible to create simple custom logic in an intuitive way (with no or little technical knowledge). It should also be possible to create complex custom logic (e.g., by an expert developer), using any technology of choice, with the minimal overhead on standard delivery. Some embodiments described herein provide an easy-to-use, flow-based custom logic editor to extend business logic using simple modeling tools and expressions.

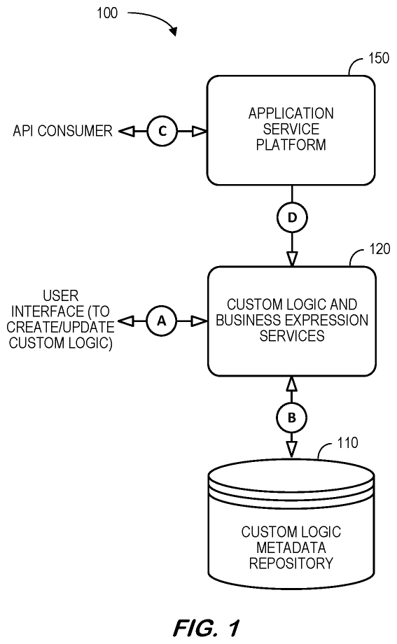

In some embodiments, a runtime service engine (a custom logic service) is created to evaluate the custom logic model and expressions. For vendor delivered services that provide for the customization and/or extension of business logic, two standard extension points and protocol are described for each microservice to call the custom logic service. The runtime service can also call external services (called external “hooks”) based on configuration information. For example, FIG. 1 is a high-level block diagram of a system 100 according to some embodiments. At (A), a user interface may be utilized to create and/or update custom logic and business expression services 120. At (B), information about the custom logic is stored in a custom logic metadata repository 110. That is, all of the metadata and expressions about the custom logic may be stored and maintained by the custom logic itself. At (C), an API consumer may send a request to an application service platform 150. Responsive to the request, the application service platform 150 may arrange for execution of the custom logic and business expression services at (D) custom logic metadata repository. An appropriate response to the request can then be automatically provided to the API consumer. A used herein, the term “automatically” may refer to a device or process that can operate with little or no human interaction.

According to some embodiments, devices, including those associated with the system 100 and any other device described herein, may exchange data via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The elements of the system 100 may store data into and/or retrieve data from various data stores (e.g., the custom logic metadata repository 110), which may be locally stored or reside remote from the application service platform 150. Although a single application service platform 150 is shown in FIG. 1, any number of such devices may be included. Moreover, various devices described herein might be combined according to embodiments of the present invention. For example, in some embodiments, the application service platform 150 and the custom logic metadata repository 110 might comprise a single apparatus. Some or all of the system 100 functions may be performed by a constellation of networked apparatuses, such as in a distributed processing or cloud-based architecture.

An operator (e.g., a database administrator) may access the system 100 via a remote device (e.g., a Personal Computer (“PC”), tablet, or smartphone) to view data about and/or manage operational data in accordance with any of the embodiments described herein. In some cases, an interactive graphical user interface display may let an operator or administrator define and/or adjust certain parameters (e.g., to set up or adjust various custom logic and/or mapping relationships) and/or provide or receive automatically generated recommendations, results, and/or alerts from the system 100. According to some embodiments, the operator may generate instructions to adjust cloud resources (e.g., a number of assigned servers) or set thresholds that, when triggered, may manually or automatically result in an adjustment of cloud resources.

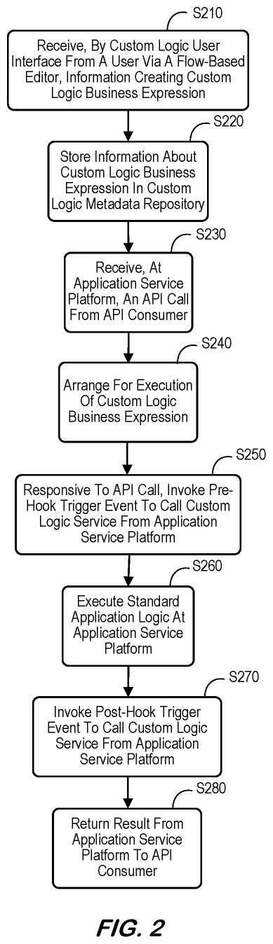

FIG. 2 illustrates a method to extend business logic for cloud application services in a secure, efficient, and accurate manner according to some embodiments. The flow charts described herein do not imply a fixed order to the steps, and embodiments of the present invention may be practiced in any order that is practicable. Note that any of the methods described herein may be performed by hardware, software, an automated script of commands, or any combination of these approaches. For example, a computer-readable storage medium may store thereon instructions that when executed by a machine result in performance according to any of the embodiments described herein.

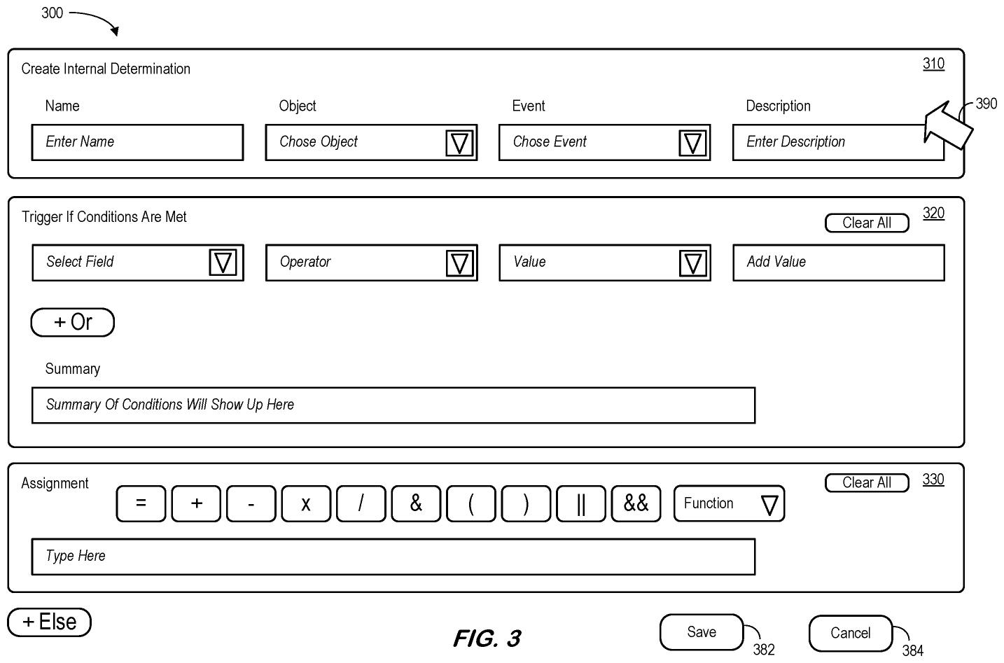

At S210, a custom logic user interface may receive, from a user via a flow-based editor, information creating a custom logic business expression. Examples of such user interfaces are described herein in connection with FIGS. 3 through 12 in accordance with some embodiments. At S220, information about the custom logic business expression may be stored in a custom logic metadata repository.

At S230, an application service platform receives an Application Programming Interface (“API”) call from an API consumer and arranges for execution of the custom logic business expression (e.g., in accordance with information in the custom logic metadata repository) at S240. Responsive to the API call, the system may invoke a pre-hook trigger event to call a custom logic service at S250. At S260, standard application logic is executed at the application service platform. At S270, the application service platform may invoke a post-hook trigger event to call the custom logic service and a result may be returned from the application service platform to the API consumer at S280.

Thus, embodiments may provide a custom logic tool is based on a flow-based editor, and any business users will be able use the tool. The tool may provide a low code or no code way to create in-application custom logic with no learning curve, no need to install new software, and no need to hire external partner developers to create the desired custom logic. Anyone can write custom logic using simple English phrases such as: total_tax=total_amount*18%, and the creation of such logic does not require a complete understanding of the application's underlying framework. Moreover, embodiments may be technology agnostic such that underlying microservices that need the extended or custom logic can be based on any technology. In addition, embodiments may provide flexibility and use an in-build approach for simple extensions (while also being open to allow for complex extensions based on any external tools or technologies).

According to some embodiments, custom logic is divided into two types of expressions: (1) determinations and (2) validations. For example:
Determinations may be used to determine and/or calculate specific field values based on certain conditions. A user may either default and/or propose the value or impose and/or mandate a certain value using determinations.
Validations may be used to implement custom logic where key users can prevent a save or issue a warning message to end users during a save based on certain conditions.

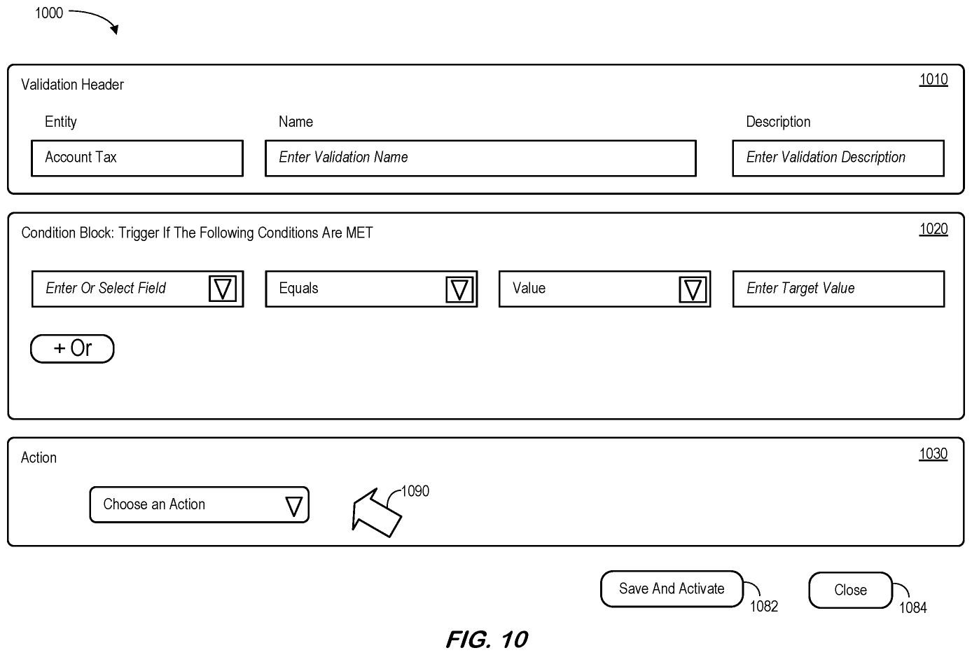

FIGS. 3 through 9 describe determination user interfaces and FIGS. 10 through 12 describe validation user interfaces according to some embodiments. In particular, FIG. 3 is a custom logic determination editor user interface 300 in accordance with some embodiments. The determination editor user interface 300 may include:
a header block 310 to specify a determination name, event and description;
a condition block 320 that key users can access to set desired conditions using a flow-based visual condition editor; and
an assignment block 330 to default and/or assign a value to a specific field—when the conditions in the condition block 320 are satisfied—and each row might be used to assign a single field value (e.g., total_amount=item_count*item_price).
   A user may access fields on the user interface 300 to enter text or select text from a drop-down menu (e.g., via touchscreen or computer mouse pointer 390). A “Save” icon 382 may be selected to store the information created by the determination editor user interface 300, and a “Cancel” icon 384 may be selected to leave the user interface 300 without saving the information.

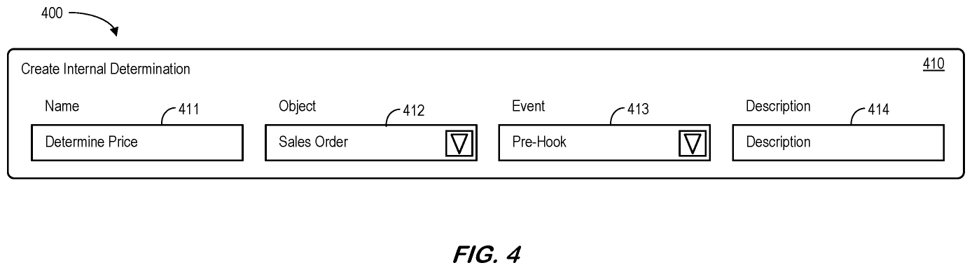

FIG. 4 is a determination editor 400 header block user interface 410 according to some embodiments. The header block user interface 410 may be used to provide a determination name 411, an object 412, and an event type 413. According to some embodiments, two different event types 413 may be supported:
pre-hook events may modify both standard and custom fields (and pre-hook determinations may be used to default and/or propose standard and custom field values); and
post-hook events may only modify custom field values (and post-hook determinations may be used to mandate and/or impose custom field values).
   The header block user interface 410 may also be used to provide a description 414 of the determination.

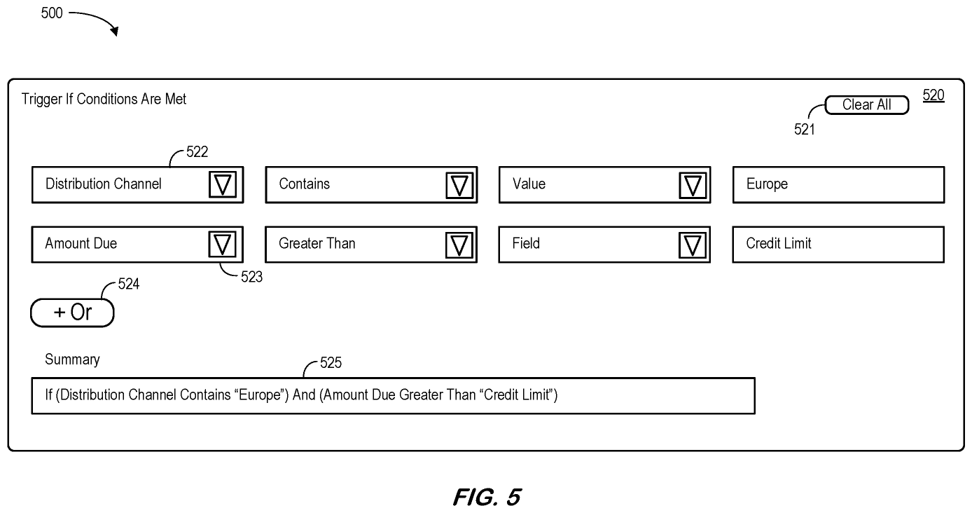

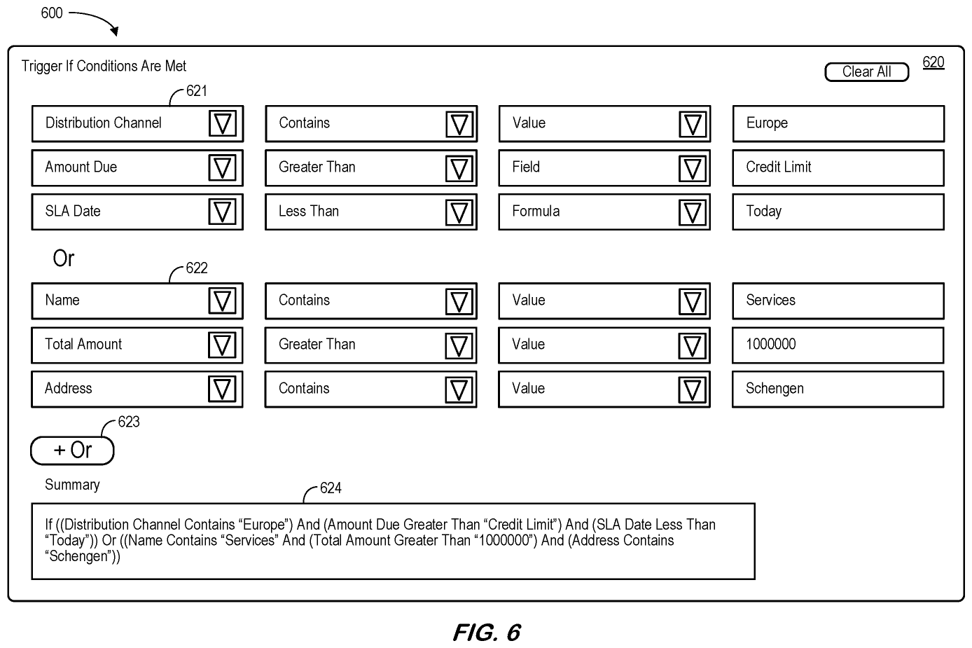

According to some embodiments, key users may specify desired conditions for a determination using a condition block. For example, FIG. 5 is a determination editor 500 condition block user interface 520 in accordance with some embodiments. A “Clear All” icon 521 may be used to reset the information in the user interface 520. The condition block user interface may be used to provide a set of conditions 522, 523 that will trigger the determination, include a condition field, a condition operator (e.g., “equals” or “contains”), and condition value information. An “Or” icon 524 may be selected to provide additional sets of the conditions, and a summary 525 may be automatically generated based on the provided conditions 522, 523. For example, FIG. 6 is a condition block 620 with multiple sets of conditions 621, 622 according to some embodiments. Selection of an “Or” icon 623 may let even more sets of conditions be added and a summary 624 may be generated showing all of the sets of conditions.

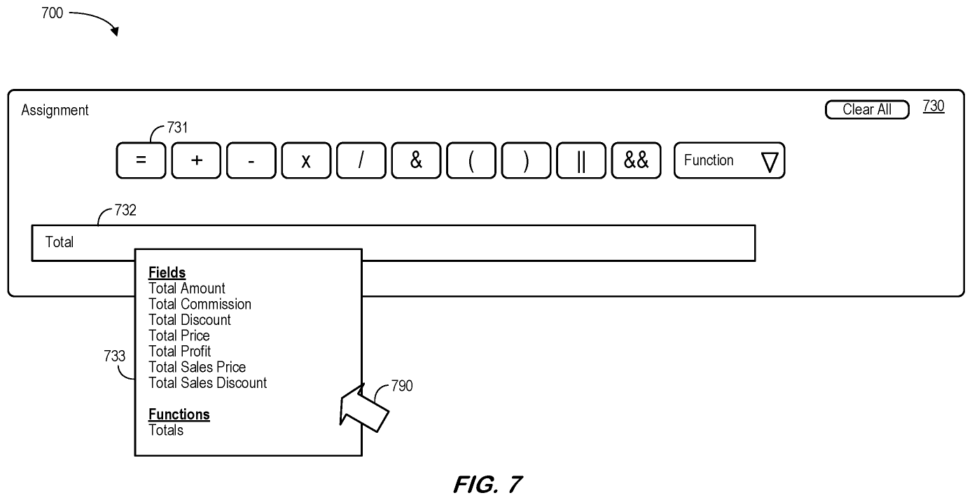

If the defined conditions are satisfied, the statements in the determination assignment block will be executed. FIG. 7 is a determination editor 700 assignment block 730 in accordance with some embodiments. Various assignment operators 731 (e.g., “=,” “+,” “&,” etc.) may be selected to be included in an assignment row 732 and field names, function names, etc. may be available in a drop-down menu 733 (e.g., via a touchscreen or computer mouse pointer 790). Each row 732 in the assignment block 730 can be used to assign and/or calculate a value to a specific field. According to some embodiments, key users can write expressions and/or calculations directly in a free-style format. For example, a row 732 might mention a target field first, followed by “=,” and then specify an expression, such as:

{status}=(‘Open’)

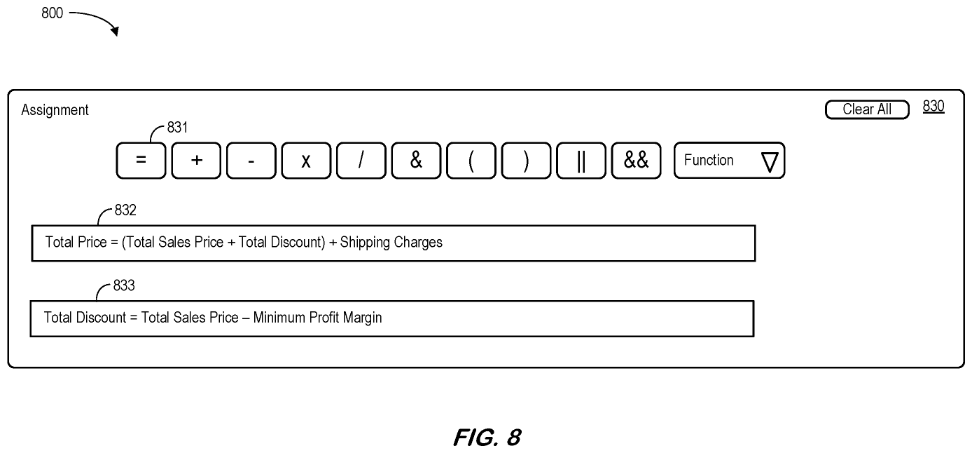

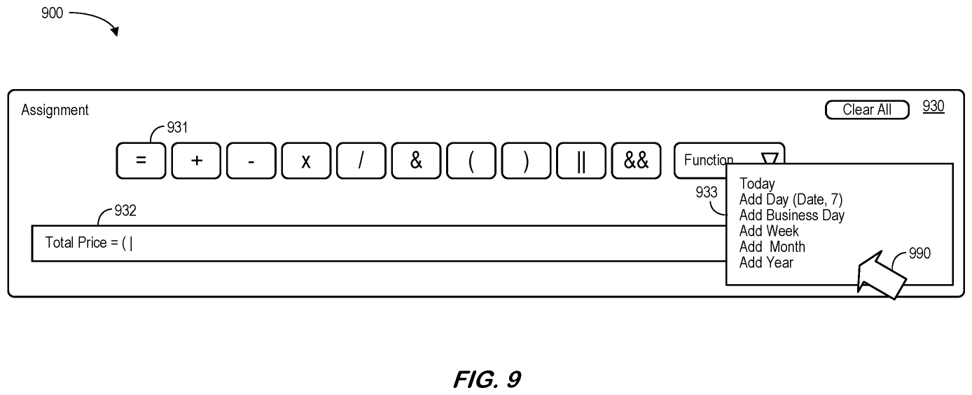

According to some embodiments, all entity fields are enclosed in curly braces (e.g., {status}, {id}, etc.). Moreover, some embodiments may support automatic suggest and automatic completions to help users write assignments. FIG. 8 is a determination editor 800 assignment block 830 where assignment operators 831 have been used to create multiple assignments 832, 833 according to some embodiments. In addition to normal assignment operators 831, some embodiments may support assignment functions. For example, FIG. 9 illustrates a determination editor 900 assignment block 930 where operators 931 may be used to define an assignment row 932. Moreover, selection “function” operator may result in display of a function drop-down menu 933 in accordance with some embodiments (e.g., and a particular function might be selected for the assignment row 932 via touchscreen or computer mouse pointer 990). According to some embodiments, a user might utilize “drag-and-drop” features to change the sequence of assignments.

In addition to determination expressions, validation expressions may be used to implement a custom logic where key users can prevent a save (or issue a warning message to end users) during a save in accordance with certain conditions. For example, FIG. 10 is a custom logic validation editor user interface 1000 according to some embodiments. The validation editor user interface 1000 may include:
a header block 1010 to specify a validation entity, name, and description;
a condition block 1020 to let key users set desired conditions using a flow-based visual condition editor; and
an action block 1030 to specify an error or warning message if the conditions defined in the condition block 1020 are satisfied.
   A “Saved and Active” icon 1082 may be selected (e.g., via computer mouse pointer 1090) to store the information created by the validation editor user interface 1000, and a “Close” icon 1084 may be selected to leave the user interface 1000 without saving the information.

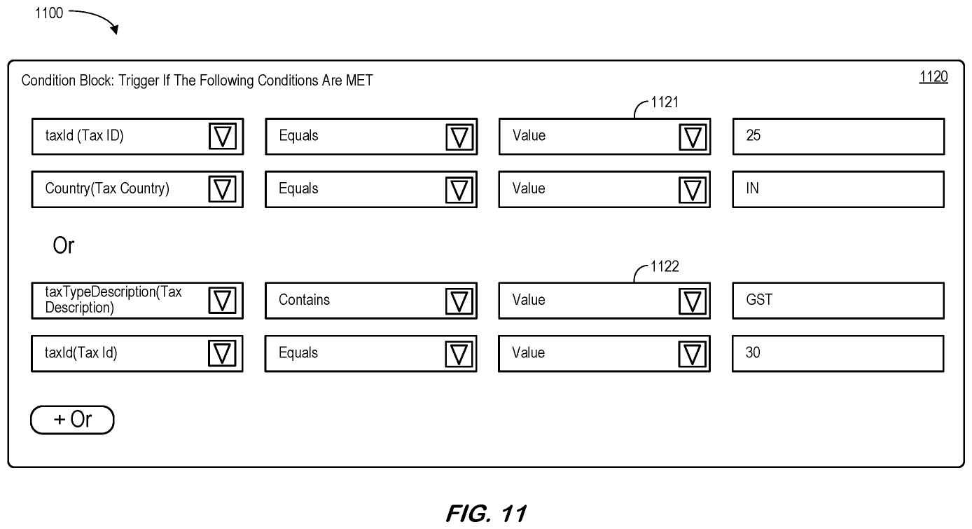

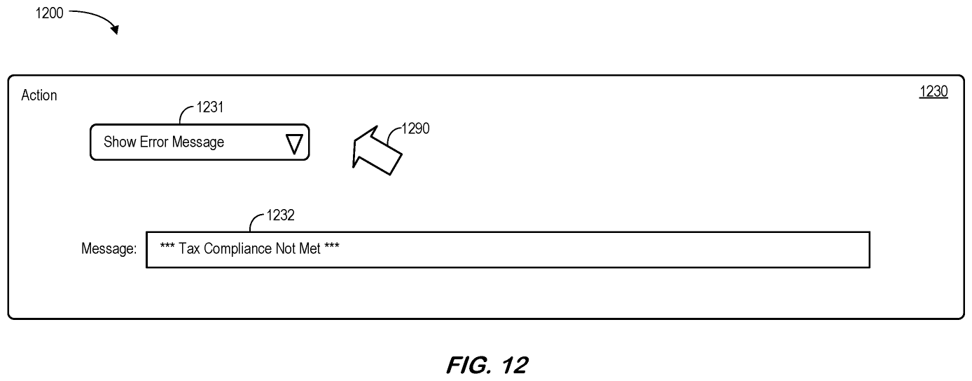

FIG. 11 is a validation editor 1100 condition block user interface 1120 in accordance with some embodiments. In this example, a message will be raised when the following conditions 1121, 1122 are met:
if (Tax ID=25 and Country=IN) or (Tax Description Contains GST and Tax ID=30).
   A key users can then specify the message details in a message action block (e.g., to raise either an error or warning message). For example, FIG. 12 is a validation editor 1200 action block user interface 1230 according to some embodiments. A user can elect to show an error message 1231 (e.g., via a touchscreen or computer mouse pointer 1290) and define the text of the error message 1232. According to some embodiments, an error message will prevent and/or block a save operation (and will alert the end user with the message text) while a warning message will allow the save operation (but will still raise the message to alert end users).

According to some embodiments, there are two broad types of custom logic implementations that are supported in the cloud native stack:
Business expression based custom logic: These validations and determinations are based on simple expressions and configured using in-build tools. These are supposed to be simple logic and limited by capabilities of business expressions and custom logic tools.
External API Hooks: These validations and determinations are based on external API calls. The external APIs could be implemented in any external platform, such as SAP® AppGyver, but may need to support a specific message structure.

Examples of custom logic trigger points may include:
An On Init Trigger Point: This type of determination is executed only for defaulting on creation of an entity. It should be executed (for a post call) only if an “on-init” flag is set in the header. In this call, data is not saved and an empty response is returned. Note that “on-init” determinations may not be executed on post calls.
A Pre-hook Trigger Point: To execute the custom determination that would be executed before the standard application logic. These determinations may be marked as “pre-hook” determinations.
A Post-hook Trigger Point: To execute the custom logic that would be executed after the standard logic. In this phase, the custom determinations (called post-hook determinations) are not allowed to change standard attributes (fields). Custom validations may also be executed in this phase.
   Note that validations may returns success or failure messages based custom logic evaluation. Determinations may set one or more attributes of an entity when the required conditions are satisfied. Determination may also change attribute-properties dynamically (e.g., read-only, mandatory, etc.).

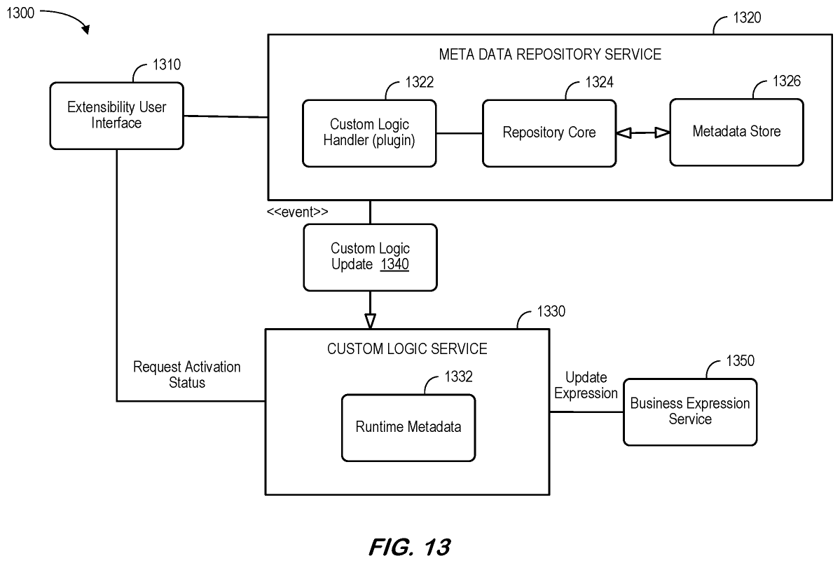

FIG. 13 is a custom logic design time framework 1300 associated with custom logic metadata for business expression based custom logic. Note that a similar flow may also be provided for external API hooks. An extensibility user interface 1310 may communicate with a metadata repository service 1320 (having a customer logic handler 1322 (e.g., a plugin), a repository core 1324, and a metadata store 1326). The extensibility user interface 1310 may also request activation status from a custom logic service 1330 (having runtime metadata 1332) which, in turn, may update expressions via a business expression service 1350.

According to some embodiments, there is a design time meta format for expressions that will be stored in the metadata repository service 1324. The custom logic service 1330 listens to the changes in the custom logic entities (via custom logic update events 1340) and transforms and/or pushes the runtime-expression to the business expression service 1350. The custom logic service 1330 abstracts an underlying runtime execution engine (the business expression service 1350 in this case). In some embodiments, it is possible to change the runtime execution engine depending on the need.

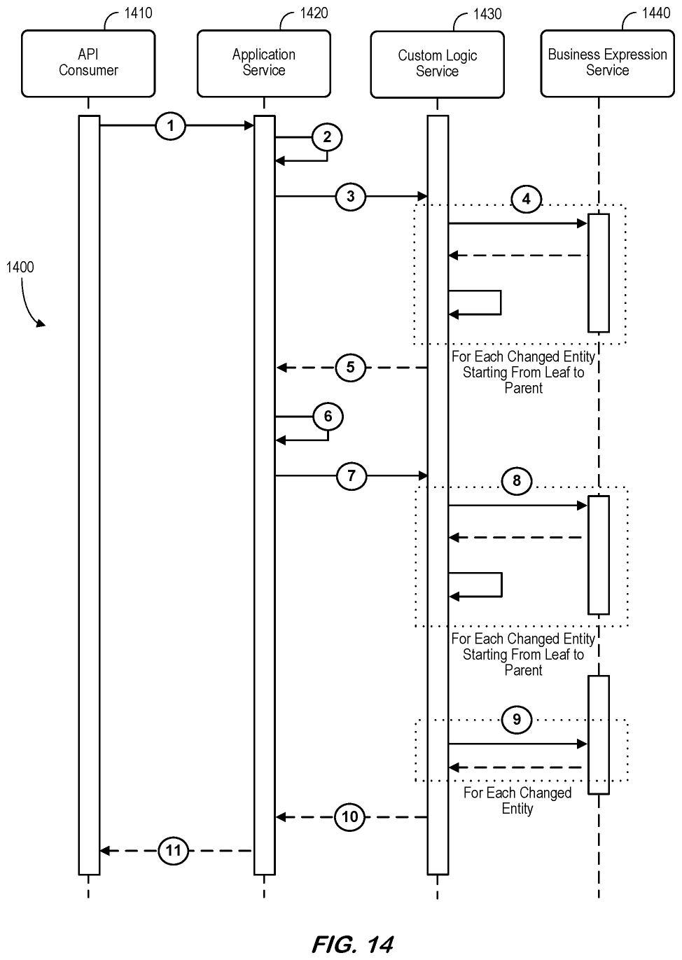

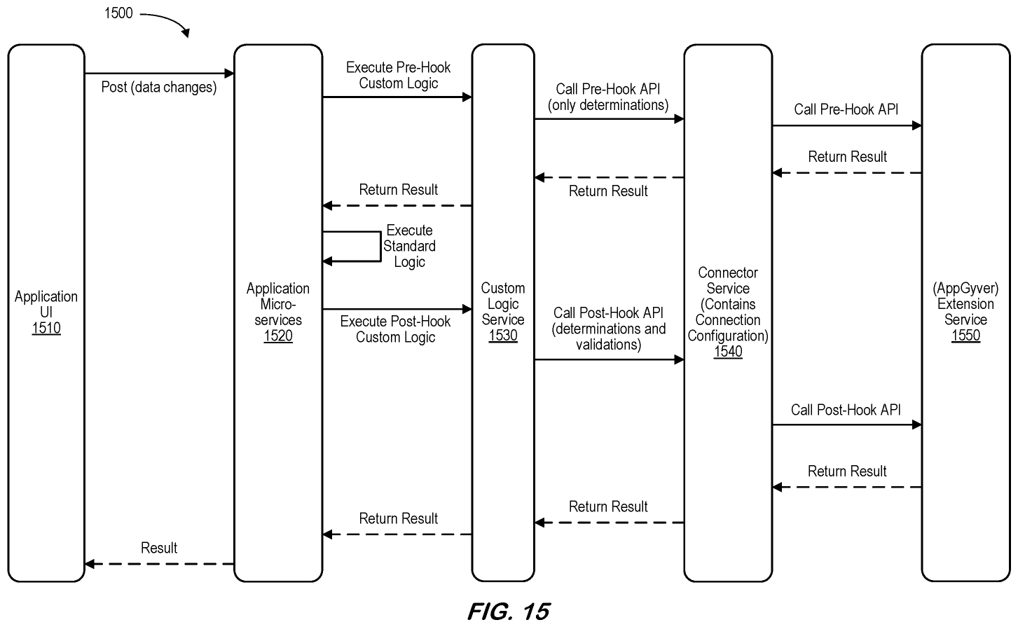

The custom logic service 1330 may store the validation and determination by replacing the expressions with an expression identifier (provided by business expression service 1350). FIG. 14 is a custom logic information flow 1400 that shows the runtime sequence of calls for business expression based custom logic. Note that a similar flow may be provided for API hook implementations where “in place” business expressions use an external API call as described with respect to FIG. 15. At (1), an API consumer 1410 calls operations (e.g., post, put, patch, delete, etc.) on any service API. This can be either on the aggregate (root) entity and/or any child entities. Note that when a child is changed, the complete aggregate is considered affected. At (2), an application service 1420 needs to pass the complete aggregate data along with the changed entities information (entity path, entity-name, and operations being performed on all root/child entity instances being changed). For this reason, the system may first need to fetch the aggregate data (except for a put or post operation on root) and merge the changes sent by the API consumer 1410.

According to some embodiments, a custom logic service 1430 will be called by the application service 1420 at two points called “pre-hook” and “post-hook” points. The pre-hook point may execute the custom determination that would be executed before the standard application logic. The post-hook point may execute the custom logic that would be executed after the standard logic. In the post-hook phase, custom determinations may not be allowed to change any standard attributes (fields) and custom validations are also executed. At (3), the application service 1420 calls the pre-hook custom logic service 1430 API with the complete aggregate data (even if only a child entity, such as item, is changed) and the changed entity information.

At (4), the custom logic service 1430 and a business extension service 1440 execute the pre-hook determination for each changed entity, starting with the leaf entity and then the parent hierarchy. For example, if an item is changed, then first the custom logic is executed on the item and then on the root. At (5), the custom logic service 1430 returns to the applications service 1420 the changed (aggregate) data merged with the changes done by the pre-hook determinations. At (6), the application service 1420 executes the standard custom-logic (determinations and validations).

At (7), the application service 1420 calls the post-hook custom logic service 1430 API with the complete aggregate data (even if only a child entity, such as item, is changed) and the changed entity information. At (8), the custom logic service 1430 and the business extension service 1440 execute the post-hook determination for each changed entity, starting with the leaf entity and then the parent hierarchy. For example, if an item is changed, then first the custom logic is executed on the item and then on the root. At (9), the custom logic service 1430 and the business execution service 1440 execute the custom validations for each changed entities instances. At (10), the custom logic service 1430 returns to the applications service 1420 the changed (aggregate) data merged with the changes done by the post-hook determinations. Note that in FIG. 14 a “changed entity” means changed instances (either at the root or child entity levels). For brevity, they are just referred to a child entity. At (11), the application service 1420 returns the result to the API consumer 1410 to complete the process.

According to some embodiments, external API hooks provide an option where customers can implement custom validations and determinations externally using any external platform (e.g., SAP® AppGyver). From the application's point of view, there will not be any change to the custom logic hooks (pre-hook and po-hook) and custom logic API. However, there an additional message entity may be needed—to connect to an external system embodiments may use a connector service. For example, FIG. 15 is a system 1500 to support API messages for custom logic in accordance with some embodiments. An application user interface 1510 may post data changes to application microservices 1520. The application microservices 1520 execute pre-hook custom logic causing a custom logic service 1530 to call pre-hook API for determinations via a connector service 1540 (e.g., containing connection configuration data) and an extension service 1550. A pre-hook result is eventually returned to the application microservices 1520 which can then execute standard logic.

The application microservices 1520 then execute post-hook custom logic causing the custom logic service 1530 to call post-hook API for determinations and validations via the connector service 1540 and the extension service 1550. A post-hook result is eventually returned to the application microservices 1520 which can provide a result to the application user interface 1510.

Some embodiments define an API message structure that is used by the external platforms to generate request and response structures for the API. The connector service 1540 may have a special mandatory header-structure that is part of this structure. In addition, the connector service 1540 may provide a unique entity for routing (to match to an external API path). In some embodiments, each application creates two additional message entities—one for the pre-hook and the other for the post-hook. These message entities may have the main entity as embedded object definition. In the metadata definition, a pre-hook message entity may have an attribute (called body) that refers to an SAP® Opportunity service entity. The pre-hook and post-hook message entities may also be defined in the same service (e.g., Opportunity). Such an approach may provide additional flexibility when an application wants to have reduced structure to pass to the external hooks (e.g., for security or data protection reasons). Also, this technique may not need special handling by the connector service 1540 and may have additional requirements associated with the repository service: the repository service should be able to provide the pre-hook and post-hook message entities based on the main entity; it should be possible to filter out the pre-hook and post-hook entities (e.g., when they should not be displayed); metadata to store an external API (e.g., trigger type, message entity, entity, API Path, communication configuration, etc.).

Other embodiments may use the main entity (e.g., Opportunity) to generate the pre-hook and post-hook messages on demand. In this case, the connector service 1540 may provide a customized method for the pre-hook and post-hook calls for specialized routing for the pre-hook and post-hooks.

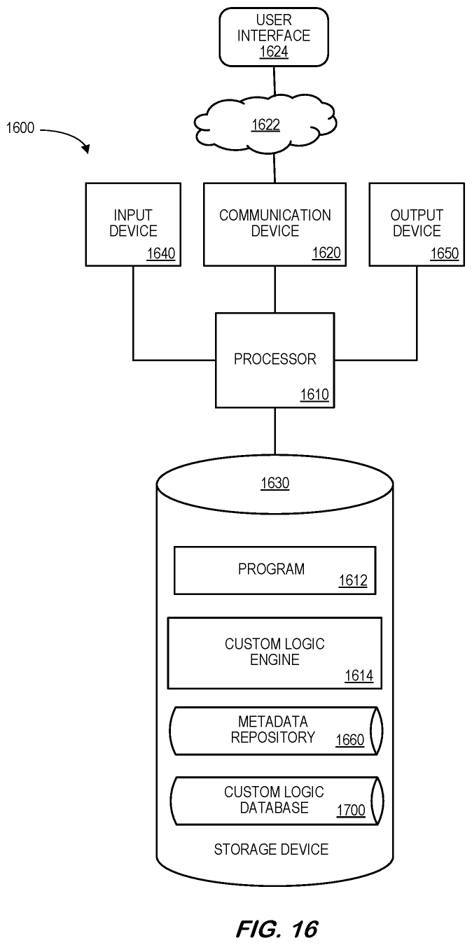

Note that the embodiments described herein may be implemented using any number of different hardware configurations. For example, FIG. 16 is a block diagram of an apparatus or platform 1600 that may be, for example, associated with the system 100 of FIG. 1 (and/or any other system described herein). The platform 1600 comprises a processor 1610, such as one or more commercially available CPUs in the form of one-chip microprocessors, coupled to a communication device 1620 configured to communicate via a communication network (not shown in FIG. 16). The communication device 1620 may be used to communicate, for example, with one or more remote user interface devices 1624 via a communication network 1622. The platform 1600 further includes an input device 1640 (e.g., a computer mouse and/or keyboard to input data about application systems or data sources) and an output device 1650 (e.g., a computer monitor to render a display, transmit recommendations or alerts (e.g., a warning signal based on a validation expression), and/or create monitoring reports). According to some embodiments, a mobile device and/or PC may be used to exchange data with the platform 1600.

The processor 1610 also communicates with a storage device 1630. The storage device 1630 can be implemented as a single database, or the different components of the storage device 1630 can be distributed using multiple databases (that is, different deployment data storage options are possible). The storage device 1630 may comprise any appropriate data storage device, including combinations of magnetic storage devices (e.g., a hard disk drive), optical storage devices, mobile telephones, and/or semiconductor memory devices. The storage device 1630 stores a program 1612 and/or custom logic engine 1614 for controlling the processor 1610. The processor 1610 performs instructions of the programs 1612, 1614, and thereby operates in accordance with any of the embodiments described herein. For example, the processor 1610 may receive, from a user via a flow-based editor, information creating a custom logic business expression (e.g., a determination or a validation). The processor 1610 may store information about the custom logic business expression and receive an API call from an API consumer. The processor 1610 may then arrange for execution of the custom logic business expression. Responsive to the API call, the processor 1610 may invoke a pre-hook trigger event to call a custom logic service. Standard application logic may then be executed, and a post-hook trigger event may be invoked by the processor 1610 to call the custom logic service. A result can then be returned from the application service platform to the API consumer.

The programs 1612, 1614 may be stored in a compressed, uncompiled and/or encrypted format. The programs 1612, 1614 may furthermore include other program elements, such as an operating system, clipboard application, a database management system, and/or device drivers used by the processor 1610 to interface with peripheral devices.

As used herein, data may be “received” by or “transmitted” to, for example: (i) the platform 1600 from another device; or (ii) a software application or module within the platform 1600 from another software application, module, or any other source.

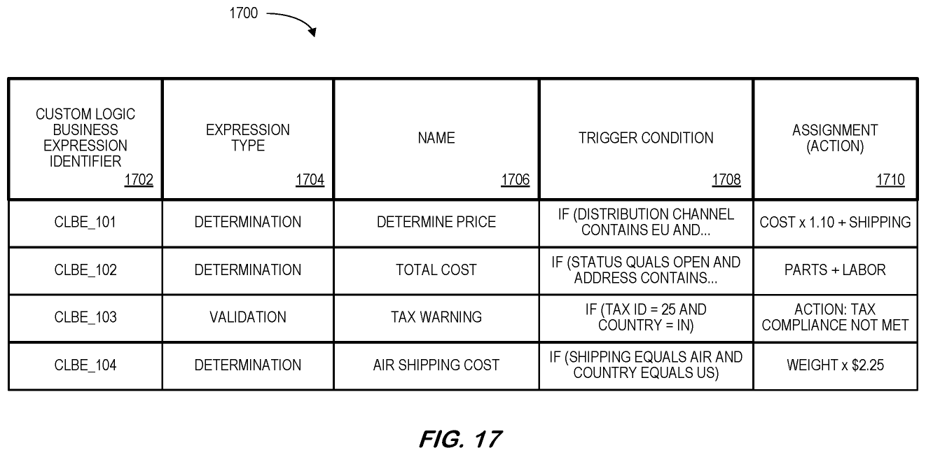

In some embodiments (such as the one shown in FIG. 16), the storage device 1630 further stores a metadata repository 1660 (e.g., containing a custom logic handler plugin, a repository core, a metadata store, etc.) and a custom logic database 1700. An example of a database that may be used in connection with the platform 1600 will now be described in detail with respect to FIG. 17. Note that the database described herein is only one example, and additional and/or different data may be stored therein. Moreover, various databases might be split or combined in accordance with any of the embodiments described herein.

Referring to FIG. 17, a table is shown that represents the custom logic database 1700 that may be stored at the platform 1600 according to some embodiments. The table may include, for example, entries identifying custom logic business expressions in connection with a cloud computing environment. The table may also define fields 1702, 1704, 1706, 1708, 1710 for each of the entries. The fields 1702, 1704, 1706, 1708, 1710 may, according to some embodiments, specify: a custom logic business expression identifier 1702, an expression type 1704, a name 1706, a trigger condition 1708, and an assignment or action 1710. The custom logic database 1700 may be created and updated, for example, when, etc.

The custom logic business expression identifier 1702 might be a unique alphanumeric label or link that is associated with logic define by a user via a user interface. The expression type 1704 might indicate, for example, whether the custom logic business expression is a determination or validation and the name 1706 might describe the purpose behind the logic. The trigger condition 1708 are the set of rules that define when the custom logic expression is satisfied, and the assignment or action 1710 indicates what steps will be performed when the trigger condition 1708 is satisfied.

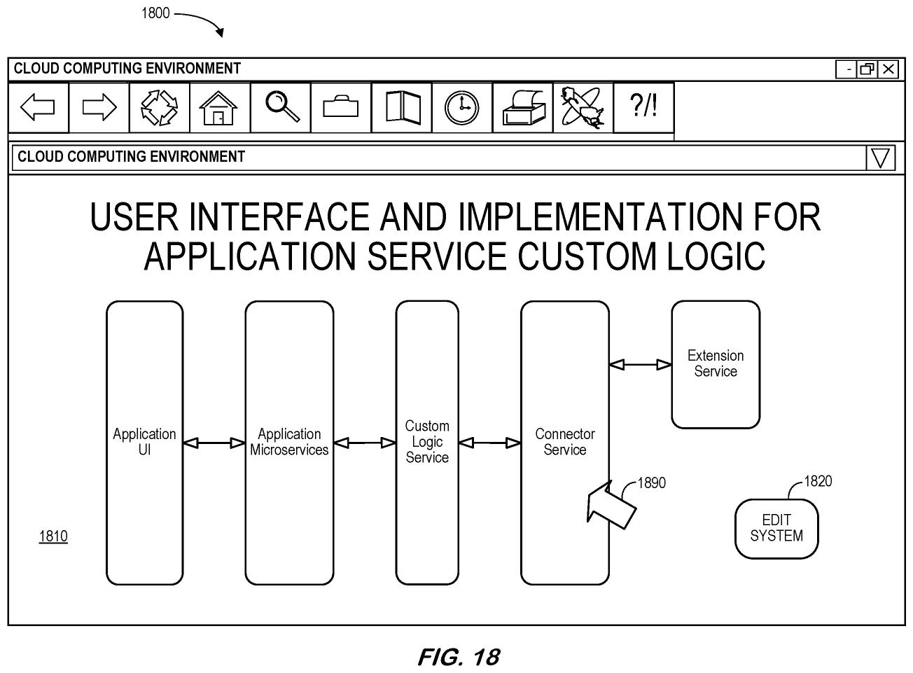

FIG. 18 is a human machine interface display 1800 in accordance with some embodiments. The display 1800 includes a graphical representation 1810 or dashboard that might be used to manage or monitor application service custom logic (e.g., associated with a cloud provider). In particular, selection of an element (e.g., via a touchscreen or computer mouse pointer 1890) might result in the display of a popup window that contains configuration data. The display 1800 may also include a user selectable “Edit System” icon 1820 to request system changes (e.g., to investigate or improve system performance).

Thus, embodiments may provide an easy to learn, intuitive, and interactive user interface and experience. Business users may use a simple, model-based editor to build conditions and/or expressions. Some embodiments also provide an advanced mode where one can freely type in the expressions. The model-based editor may offer field and/or attribute selection dropdown menus where one can select the desired field, an operator dropdown menu to select the desired operator, selection of a target constant value or field using the dropdown menus, etc.

Embodiments may also let a user bring external logic to make use of third-party tools and create custom functions and/or logic using any language. The system may invoke/call these third-party validations and/or determinations using external hooks. For example, a user might build a lambda function to calculate the pricings/discount based on complex conditions in a third-party tool and hook the same in the cloud using custom logic external hooks functionality. During normal business operations and instance save, a payload is sent to third party tool for execution of custom function—the returned result/payload is again processed by a custom logic service and sent back to the respective application. In this way, a customer can create custom logic using any third-party vendor tools and execute the synchronous custom logic outside the cloud infrastructure.

Some embodiments create in-application validations and determinations from external calls and/or create reusable packages. Embodiments may expose design time APIs to create these in-application custom logic expressions. Third-party tools having integrations/synergy can create these in-application validations and/or determinations out-of-the-box without making customers login and manually create the custom logic. This is also useful to create any reusable package which is common to a particular set of customers or the whole industry. For example, partners or third-party tools or vendors can create a set of custom logic expressions which common for many customers and deploy it to many desired customers and landscape with a single click and push operation.

Embodiments may also provide an immediate/instant application of custom logic. Unlike traditional custom logic tools (which has its own deployment process), custom logic created in accordance with some embodiments will be applicable instantly. One can test the changes almost immediately and can perform the desired corrections if required. This may reduce time provide agility during the custom logic creation process.

Moreover, some embodiments may execute in same Logical Unit of Work (“LUW”). The custom logic may run in the same LUW session (e.g., in a synchronous call) during a business instance save. This helps makes sure that consistency is maintained during the end user interactions with the business data and/or instance. Only those sets of business data which pass the custom validations are allowed to be saved (and others will be rejected with a custom message set by the administrator). Determinations can ensure that certain field values are pre-populated (or imposed) thereby enforcing certain business processes and/or decisions.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

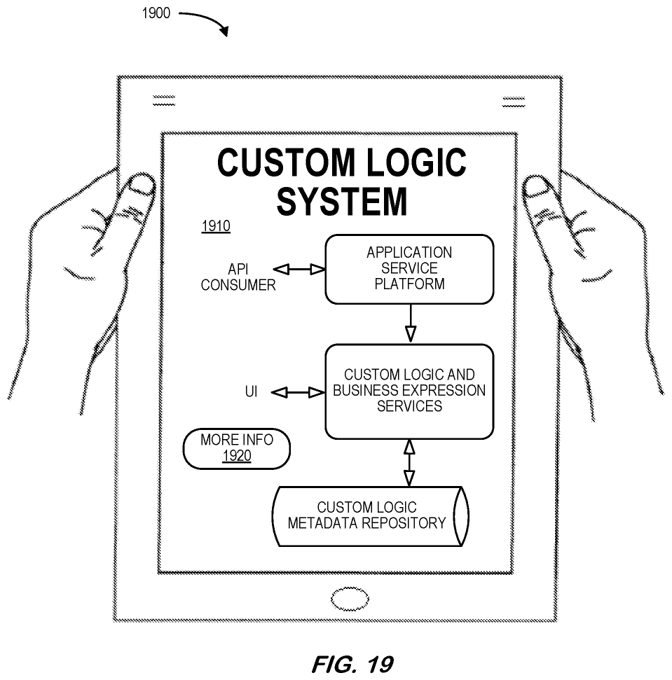

Although specific hardware and data configurations have been described herein, note that any number of other configurations may be provided in accordance with some embodiments of the present invention (e.g., some of the data associated with the databases described herein may be combined or stored in external systems). Moreover, although some embodiments are focused on particular types of logic expressions, any of the embodiments described herein could be applied to other types of logic. Moreover, the displays shown herein are provided only as examples, and any other type of user interface could be implemented. For example, FIG. 19 shows a handheld tablet computer 1900 rendering a custom logic display 1910 that may be used to view or adjust system operation and/or to request additional data (e.g., via a “More Info” icon 1920).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A system to extend business logic for cloud application services, comprising:
a custom logic user interface to receive, from a user via a flow-based editor, information creating a custom logic business expression;
a custom logic metadata repository to store information about the custom logic business expression; and
an application service platform, including:
a computer processor, and
a memory storage device, coupled to the computer processor, including instructions that, when executed by the computer processor, enable the application service platform to:
(i) receive an Application Programming Interface (“API”) call from an API consumer,
(ii) arrange for execution of the custom logic business expression in accordance with information in the custom logic metadata repository,
(iii) responsive to the API call, invoke a pre-hook trigger event to call a custom logic service,
(iv) execute standard application logic,
(v) invoke a post-hook trigger event to call the custom logic service, and
(vi) return a result from the application service platform to the API consumer.

2. The system of claim 1, wherein the user information creating the custom logic business expression is received via a no-code tool of the custom logic user interface.

3. The system of claim 1, wherein the custom logic business expression comprises a determination.

4. The system of claim 3, wherein the information creating the determination is received via: (i) a header block of the flow-based editor including a determination name, event type, and description, (ii) a condition block of the flow-based editor including a plurality of trigger conditions, and (iii) an assignment block of the flow-based editor including statements to be executed when the trigger conditions in the condition block are satisfied.

5. The system of claim 1, wherein the custom logic business expression comprises a validation.

6. The system of claim 5, wherein the information creating the validation is received via: (i) a header block of the flow-based editor including a validation name and description, (ii) a condition block of the flow-based editor including a plurality of trigger conditions, and (iii) an action block of the flow-based editor to specify an error or warning message to be displayed when the trigger conditions in the condition block are satisfied.

7. The system of claim 1, wherein the custom logic user interface and the flow-based editor support drop-down selections and automatic term completion.

8. The system of claim 1, wherein the API call from the API consumer includes change data.

9. The system of claim 8, wherein the pre-hook trigger event includes changed entities information based on the change data.

10. The system of claim 9, wherein the custom logic service executes pre-hook determination expressions via a business expression service for each changed entity from leaf to parent.

11. The system of claim 8, wherein the standard application logic includes determinations and validations.

12. The system of claim 8, wherein the post-hook trigger event includes changed entities information based on the change data.

13. The system of claim 12, wherein the custom logic service executes post-hook determination expressions via a business expression service for each changed entity from leaf to parent.

14. The system of claim 13, wherein the custom logic service executes post-hook validation expressions via the business expression service.

15. A computer-implemented method to extend business logic for cloud application services, comprising:
receiving, by a custom logic user interface from a user via a flow-based editor, information creating a custom logic business expression;
storing information about the custom logic business expression in a custom logic metadata repository;
receiving at an application service platform an Application Programming Interface (“API”) call from an API consumer;
arranging, by a computer processor of the application service platform, for execution of the custom logic business expression in accordance with information in the custom logic metadata repository;
responsive to the API call, invoking a pre-hook trigger event to call a custom logic service from the application service platform;
executing standard application logic at the application service platform;
invoking a post-hook trigger event to call the custom logic service from the application service platform; and
returning a result from the application service platform to the API consumer.

16. The method of claim 15, wherein the user information creating the custom logic business expression is received via a no-code tool of the custom logic user interface.

17. The method of claim 15, wherein the custom logic business expression comprises a determination, and the information creating the determination is received via: (i) a header block of the flow-based editor including a determination name, event type, and description, (ii) a condition block of the flow-based editor including a plurality of trigger conditions, and (iii) an assignment block of the flow-based editor including statements to be executed when the trigger conditions in the condition block are satisfied.

18. The method of claim 15, wherein the custom logic business expression comprises a validation and the information creating the validation is received via: (i) a header block of the flow-based editor including a validation name and description, (ii) a condition block of the flow-based editor including a plurality of trigger conditions, and (iii) an action block of the flow-based editor to specify an error or warning message to be displayed when the trigger conditions in the condition block are satisfied.

19. A non-transitory, computer readable medium having executable instructions stored therein to perform a method to extend business logic for cloud application services, the method comprising:
receiving, by a custom logic user interface from a user via a flow-based editor, information creating a custom logic business expression;
storing information about the custom logic business expression in a custom logic metadata repository;
receiving at an application service platform an Application Programming Interface (“API”) call from an API consumer;
arranging, by a computer processor of the application service platform, for execution of the custom logic business expression in accordance with information in the custom logic metadata repository;
responsive to the API call, invoking a pre-hook trigger event to call a custom logic service from the application service platform;
executing standard application logic at the application service platform;
invoking a post-hook trigger event to call the custom logic service from the application service platform; and
returning a result from the application service platform to the API consumer.

20. The medium of claim 19, wherein the user information creating the custom logic business expression is received via a no-code tool of the custom logic user interface.

21. The medium of claim 19, wherein the API call from the API consumer includes change data, the pre-hook trigger event includes changed entities information based on the change data, and the custom logic service executes pre-hook determination expressions via a business expression service for each changed entity from leaf to parent.

22. The medium of claim 19, wherein the API call from the API consumer includes change data, the post-hook trigger event includes changed entities information based on the change data, and the custom logic service executes post-hook determination expressions via a business expression service for each changed entity from leaf to parent.
